(19) United States
(12) Patent Application Publication
(10) Pub. No.: US 2008/0112010 A1
(43) Pub. Date: May 15, 2008

(54) Apparatus, system, method, and program for managing printing operations

(75) Inventor: Atsushi Matsuo, Hyogo (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/982,924

(22) Filed: Nov. 6, 2007

(30) Foreign Application Priority Data
Nov. 14, 2006 (JP) 2006-308024

(51) Int. Cl. G06F 3/12

(52) U.S. Cl. 358/1.15

(57) ABSTRACT

The present invention provides a printing managing apparatus which can set an appropriate use restriction according to using situation of a user, based on the result of analysis of use history of an image processing device. An external server, connected to the image processing device by way of a LAN, comprises a communicating portion that receives a job processing result from the image processing device, a data holding portion that stores the job processing result as use history data of the image processing device, and a data control portion. The data control portion analyzes the using situation for each user who has executed job processing, based on the use history data stored in the data holding portion, and performs setting of the use restriction of the image processing device for each user, based on the result of the analysis.

### CROSS-NOTING PARAGRAPH

This Non-provisional application claims priority under 35 U.S.C. §119(a) on Patent Application No. 2006-308024 filed in JAPAN on Nov. 14, 2006, the entire contents of which are hereby incorporated herein by reference.

### FIELD OF THE INVENTION

The resent invention relates generally to an apparatus, system, method, and program for managing printing operations, and more particularly, to a peripheral that performs image processing and a printing managing apparatus that manages the peripheral, and to a printing managing apparatus, a printing managing system, a printing managing method, and a printing managing program for a manager to perform monitoring, management, and restriction for each user.

### BACKGROUND OF THE INVENTION

At present, in an environment in which a computer is used, printing has become an indispensable function and various types of image processing devices such as a printer, a scanner, and a facsimile device are in wide spread. Since expenses of consumables are increasing in accordance with the spread of the image processing devices, the necessity is increasing of a system capable of easily performing management of wasteful printing and management for each user.

In such situation, as shown in, for example, Japanese Laid-Open Patent Publication No. 2004-070553, a method is proposed by which a manager sets restriction of use such as the number of sheets of paper and functions to be used by a user, and at the time of using the image processing device by the user, the printing is permitted based on thus set restriction of use and a history of use, and in this method, all the management is performed by the manager with respect to the restriction of use regarding the image processing device.

However, conventional systems have a problem that the restriction of use is set that is not suitable for the user, such as setting a flat number of sheets to be used for the user who frequently uses the image processing device for a certain period of time or setting an excessive number of sheets to be used for the user with a low frequency of use, since the situation of use of each user varies depending on the period of time and the purpose for which the user uses the image processing device even if the restriction of use is set by the manager. The manager is required to change the number of sheets or the functions to be used according to the situation of use of each user and the time taken for such maintenance is also a problem.

### SUMMARY OF THE INVENTION

It is therefore an object of the present invention to provide a printing managing apparatus, a printing managing system, a printing managing method, and a program designed to be capable of setting an appropriate restriction of use according to the situation of use by a user, based on the result of analysis of a use history of an image processing device.

Another object of the present invention is to provide a printing managing apparatus connectable to an image processing device by way of a network, comprising: a communicating portion that receives a job processing result from the image processing device; a use history data holding portion that stores the job processing result as use history data of the image processing device; an analyzing portion that analyzes using situation for each user who has executed job processing based on the use history data; a use restriction setting portion that performs setting of use restriction of the image processing device for each user based on the result of the analysis by the analyzing portion.

Another object of the present invention is to provide a printing managing apparatus, wherein the use restriction setting portion periodically changes the setting of the use restriction for each user.

Another object of the present invention is to provide a printing managing apparatus, wherein the use restriction setting portion judges whether the using situation of the user changes periodically based on the result of the analysis by the analyzing portion, and if the situation changes periodically, performs the setting of the use restriction based on the setting of the use restriction of the preceding cycle.

Another object of the present invention is to provide a printing managing apparatus, wherein the use restriction setting portion judges whether the using situation of the user is in an increasing tendency based on the result of the analysis by the analyzing portion, and if the situation is in the increasing tendency, performs the setting of the use restriction so that the user may make more use of the image processing device than the previous time.

Another object of the present invention is to provide a printing managing apparatus, wherein the use restriction setting portion judges whether the using situation of the user is in an decreasing tendency based on the result of the analysis by the analyzing portion, and if the situation is in the decreasing tendency, performs the setting of the use restriction so that the user may make less use of the image processing device than the previous time.

Another object of the present invention is to provide a printing managing apparatus, connected to a manager terminal by way of the communicating portion and equipped with a notifying portion that notifies the manager terminal of the use restriction set by the use restriction setting portion by way of the communicating portion, wherein the use restriction setting portion changes the use restriction based on a request for correction from the manager terminal.

Another object of the present invention is to provide a printing managing apparatus, wherein the use restriction is either one of an allowable number of sheets of paper, an allowable upper-limit amount of money, and an allowable function.

Another object of the present invention is to provide a printing managing system comprising the printing managing apparatus and an image processing device connected to the printing managing apparatus by way of a network, wherein the image processing device executes image processing based on the use restriction for each user set by the printing managing apparatus.

Another object of the present invention is to provide a printing managing method performed by a printing managing apparatus connectable to an image processing device by way of a network, comprising steps of: receiving a job processing result from the image processing device; storing the job processing result as use history data of the image processing device; analyzing using situation for each user who has executed job processing based on the use history data; and performing setting of use restriction for each user of the image processing device based on the result of the analysis.

Another object of the present invention is a program for executing a function as the printing managing apparatus.

### BRIEF DESCRIPTION OF THE DRAWINGS

FIG. 1 is a schematic diagram of a configuration example of a printing managing system according to one embodiment of the present invention;

FIG. 2 is a functional block diagram of a configuration example of an external server, an image processing device, and an information processing device shown in FIG. 1;

FIG. 3 is a flow chart for description of one example of processing of receiving the job result from the image processing device, confirming contents of the job result at a data control portion, and storing it at a data holding portion, in the external server;

FIG. 4 is a chart of one example of use history data stored in the data holding portion of the external server;

FIG. 5 is a flow chart for description of one example of processing of reading in the use history data stored in the data holding portion, aggregating the use history data of a specified user and analyzing a using tendency of the user, and thereafter setting use restriction information of the image processing device for the user, in the data control portion of the external server;

FIG. 6 is a flow chart for description of one example of processing of reading in the use history data stored in the data holding portion, aggregating the data for a specified user, and storing the result of aggregation in the data holding portion, at the data control portion of the external server;

FIG. 7 is a chart of one example of the result of aggregation stored in the data holding portion of the external server;

FIG. 8 is a flow chart for description of one example of processing of reading in the result of aggregation and analytical index data stored in the data holding portion, analyzing on the basis of the analytical index data for the specified user, and storing the result of analysis in the data holding portion, at the data control portion of the external server;

FIG. 9 is a chart of one example of the analytical index data stored in the data holding portion of the external server;

FIGS. 10A and 10B are charts of one example of the result of analysis stored in the data holding portion of the external server;

FIGS. 11A and 11B are charts of another example of the result of analysis stored in the data holding portion of the external server;

FIGS. 12A and 12B are charts of another example of the result of analysis stored in the data holding portion of the external server;

FIGS. 13A and 13B are charts of another example of the result of analysis stored in the data holding portion of the external server;

FIG. 14 is a flow chart for description of one example of processing of setting the use restriction information based on specified use restriction index data, from the result of analysis by analyzing processing of step S12 shown in FIG. 5 and storing the use restriction information in the data holding portion, at the data control portion of the external server;

FIG. 15 is a flow chart for description of one example of processing of setting the use restriction information based on the analysis result and the use restriction index data stored in the data holding portion, for the use restriction information of the user read in at step S43 shown in FIG. 14 and storing the information in the data holding portion, at the data control portion of the external server;

FIG. 16 is a flow chart for description of other example of processing of setting the use restriction information based on the analysis result and the use restriction index data stored in the data holding portion, for the use restriction information of the user read in at step S43 shown in FIG. 14 and storing the information in the data holding portion, at the data control portion of the external server;

FIG. 17 is a flow chart for description of other example of processing of setting the use restriction information based on the analysis result and the use restriction index data stored in the data holding portion, for the use restriction information of the user read in at step S43 shown in FIG. 14 and storing the information in the data holding portion, at the data control portion of the external server;

FIG. 18 is a flow chart for description of other example of processing of setting the use restriction information based on the analysis result and the use restriction index data stored in the data holding portion, for the use restriction information of the user read in at step S43 shown in FIG. 14 and storing the information in the data holding portion, at the data control portion of the external server;

FIG. 19 is a chart of one example of the use restriction information of the user stored in the data holding portion of the external server;

FIG. 20 is a chart of one example of the system's default use restriction information stored in the data holding portion of the external server; and

FIG. 21 is a diagram of one example of a screen displayed on the information processing device when the external server 11 notifies the manager of the use restriction information output at step S13 shown in FIG. 5.

### PREFERRED EMBODIMENTS OF THE INVENTION

In the following, description will be made of preferred embodiments of a printing managing apparatus, a printing managing system, a printing managing method, and a program of the present invention, with reference to the accompanying drawings.

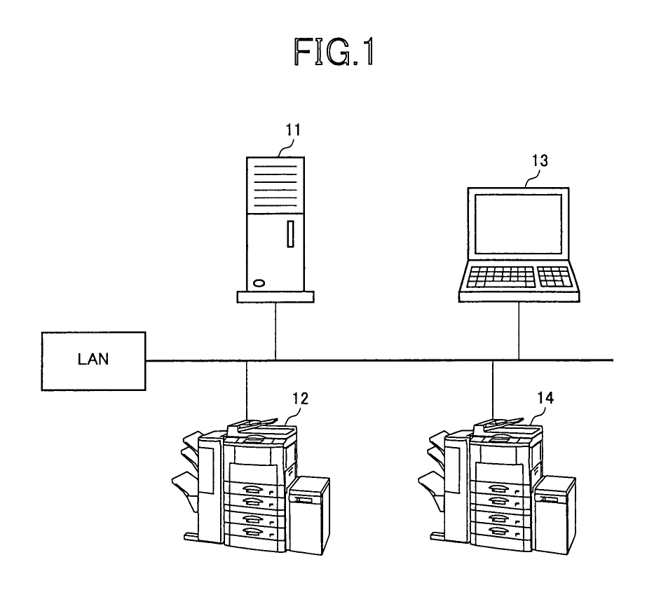

FIG. 1 is a schematic diagram of a configuration example of a printing managing system according to one embodiment of the present invention. In FIG. 1, reference numeral 11 indicates an external server as a printing managing apparatus of the present invention, reference numerals 12 and 14 indicate image processing devices such as digital multi-functional machines, and reference numeral 13 indicates an information processing device such as a PC. The external server 11, the image processing devices 12 and 14, and the information processing device 13 make up the printing managing system. The external server 11 is connected to the information processing device 13 and the image processing devices 12 and 14 by way of a network such as a LAN. It may be so arranged that a plurality of image processing devices and information processing devices are connected to this network.

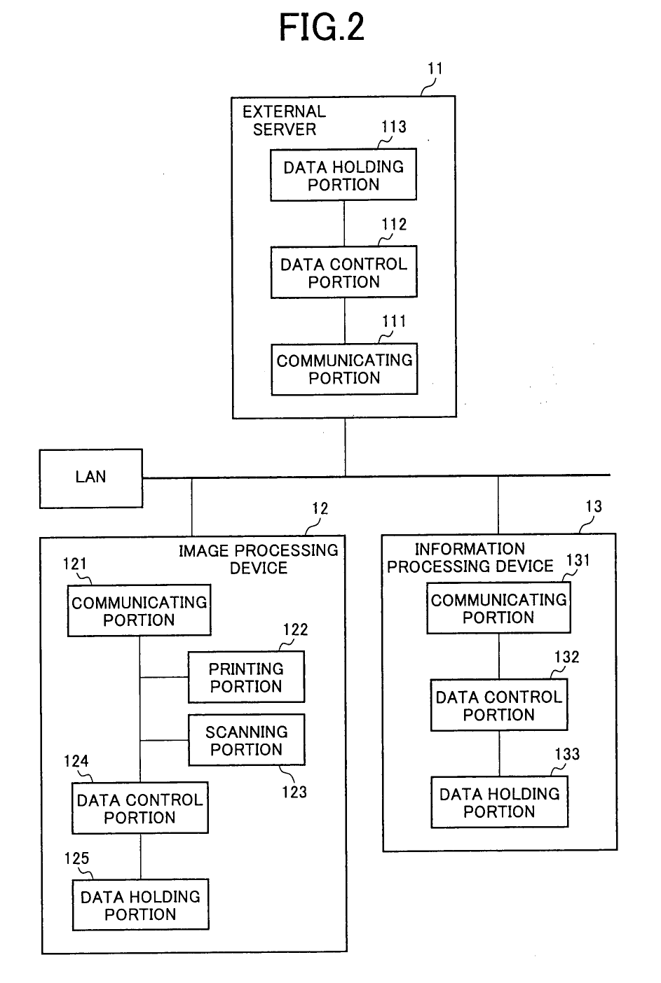

FIG. 2 is a functional block diagram of a configuration example of the external server 11, the image processing device 12, and the information processing device 13 shown in FIG. 1.

The image processing device 12 has at least one or more functions out of printing, copying, scanning, and faxing functions, is an image processing device capable of connecting to the network, and comprises at least a communicating portion 121, a printing portion 122, a scanning portion 123, a data control portion 124, and a data holding portion 125 as its constituent elements.

The communicating portion 121 is equipped with an interface capable of communicating with the external server 11 and the information processing device 13 and sends and receives data by way of the network such as the LAN.

The printing portion 122 prints the printing data received from the information processing device 13 or the printing data read and processed by the scanning portion 123.

The scanning portion 123, at the time of a copying or scanning job, reads a set document and sends thus read data to the printing portion 122 or the data holding portion 125 by way of the data control portion 124.

The data control portion 124 is composed of a CPU, a memory, etc., and controls processing of storing the data including at least user information of a user who has used the image processing device 12, printing information of the image processing device 12, and the number of sheets of paper ejected by the image processing device 12. The data control portion 124 may be a control portion that controls each processing of the image processing device 12 including scanning processing and printing processing.

The data holding portion 125 stores job results created by the data control portion 124 that include the user information of the user who has used the image processing device 12, printing information of the image processing device 12, the number of sheets of paper ejected by the image processing device 12, etc.

Next, the external server 11 corresponds to the printing managing apparatus of the present invention, has at least a communicating portion 111, a data control portion 112, and a data holding portion 113 as its constituent elements, and may be a host computer that controls the image processing device 12.

The communicating portion 111 is equipped with an interface capable of communicating with the image processing device 12 and the information processing device 13 and sends and receives various data, such as reception of a job processing result from the image processing device 12, by way of the network such as the LAN.

The data control portion 112 corresponds to various portions shown below including an analyzing portion and a use restriction setting portion, is composed of a CPU, a memory, etc., and the printing managing program stored in the memory is executed by the CPU. A storage place of the printing managing program may be a recording medium such as a hard disc installed in the external server 11.

This printing managing program executes functions as the storage control portion that stores, in use history data of the data holding portion 113, the job result sent from the image processing device 12 after execution of a job or the job result collected from the image processing device 12 by sending a command requesting for the job result from the external server 11 to the image processing device 12, the aggregating portion that aggregates the use history for each user from the use history data of the data holding portion 113, the analyzing portion that calculates using tendency of the user and the image processing device 12 from analytic index data stored in the data holding portion 113 and the result of aggregation made at the aggregating portion, the use restriction setting portion that sets the use restriction information for permitting the use of the image processing device 12 for each user from use restriction index data stored in the data holding portion 113 and the result of analysis made at the analyzing portion, and the storage control portion that controls to store the use history data collected from the image processing device 12, the result of aggregation made at the aggregating portion, the analysis result calculated by the analyzing portion, and the use restriction information set by the use restriction in the data holding portion 113.

The data holding portion 113 corresponds to the use history data holding portion of the present invention and stores the use history data collected by the external server 11, the result of aggregation, the result of analysis and the analytical index data used for the analysis, and the use restriction information and the use restriction index data used for the setting thereof.

The information processing device 13 corresponds to a manager terminal of the present invention, is specifically, for example, a PC (personal computer), etc., has at least a communicating portion 131, a data control portion 132, and a data holding portion 133 as its constituent elements, and may be a client computer that performs a system control of the image processing device 12 and a peripheral capable of communicating with the external server 11.

The communicating portion 131 is equipped with an interface capable of communicating with the external server 11 and the image processing device 12 and sends and receives the data by way of the network such as the LAN.

The data control portion 132 is composed of a CPU, a memory, etc., and at least confirms and compiles the use restriction information received from the external server 11 and sends the use restriction information to the external server 11. The data control portion 132 may be a control portion that controls the information processing device 13 as a whole. It may also be so arranged that the data control portion 132 will control the processing of sending printing data for using the image processing device 12 from the communicating portion 131 and the processing of storing the printing data in the data holding portion 133.

The data holding portion 133 stores the printing data for using the image processing device 12 created at the data control portion 132 and the use restriction information received from the external server 11.

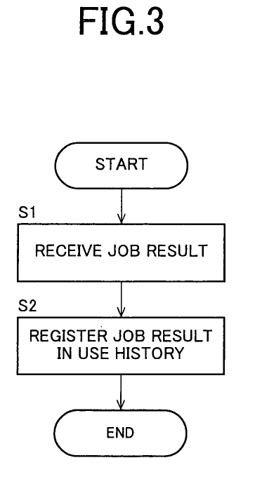

FIG. 3 is a flow chart for description of one example of processing of receiving the job result from the image processing device 12, confirming contents of the job result at the data control portion 112, and storing the job result in a data holding portion 113, in the external server 11.

Firstly, the external server 11, by the communicating portion 111, receives the result of the job executed at the data control portion 124 of the image processing device 12 (step S1). Kinds of the job result are copying, printing, scanning, faxing, etc. Next, the data control portion 112 reads in the use history data stored in the data holding portion 113, registers the data written in the job result received at step S1 in the use history data, and stores the data in the data holding portion 113 (step S2). Each time the job result is received from the image processing device 12, this flow is executed and the use history data are updated. It may be so arranged that the device to be controlled is not limited to the image processing device 12 but will be extended to other image processing devices as well.

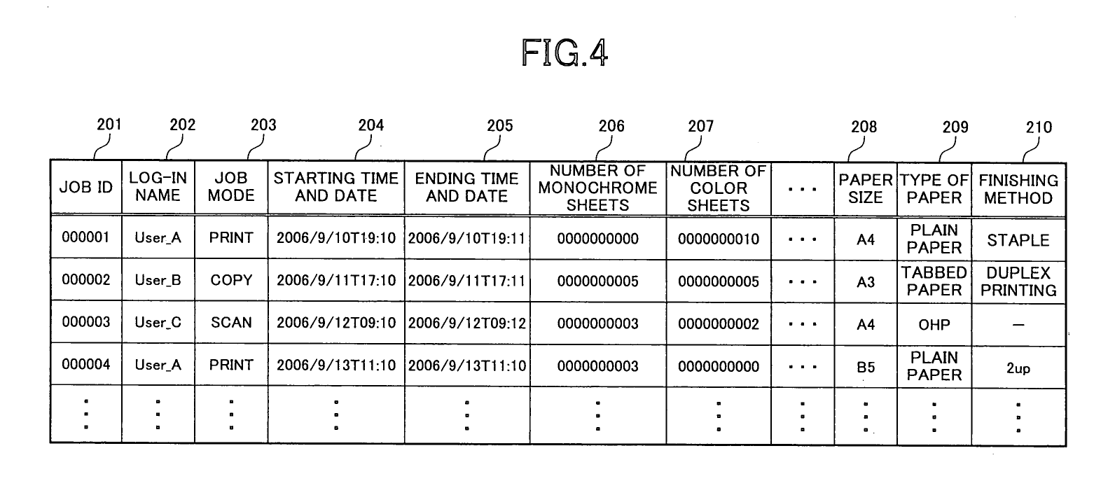

FIG. 4 is a chart of one example of the use history data stored in the data holding portion 113 of the external server 11. The job result sent from the image processing device 12 includes a job ID 201, a log-in name 202, a job mode 203, a starting time and date 204, an ending time and date 205, the number of monochrome sheets 206, the number of color sheets 207, a paper size 208, a type of paper 209, and a finishing method 210.

The job ID 201 is job identifying information generated at the time of execution of a job at the image processing device 12.

The log-in name 202 indicates the name of the user who has logged in the image processing device 12 and executed the job.

The job mode 203 indicates the kind of job to be executed at the image processing device 12 and is described as “PRINT” in the case of the printing job, as “COPY” in the case of the copying job, as “SCAN” in the case of the scanning job, and as “FAX” in the case of the faxing job.

The starting time and date 204 and the ending time and date 205 indicate the time and date on which the job is started and the time and date on which the job is completed, respectively, in the image processing device 12. For example, in the case of the job with the job ID “000001”, the starting time and date is described as “2006/9/10T19:10” and the ending time and date as “2006/9/10T19:11” and this indicates that, in the image processing device 12, the printing job is started at 19:10, Sep. 10, 2006 and is completed at 19:11, Sep. 10, 2006.

The number of monochrome sheets 206 and the number of color sheets 207 mean the number of sheets of respective colors executed in the image processing device 12 and the number of sheets of paper printed is written in the case of the printing or copying job, the number of sheets of scanned document in the case of the scanning job, and the number of sheets of paper printed for fax reception or the number of sheets of document scanned for fax transmission in the case of the faxing job.

The paper size 208 indicates the size of the paper used for jobs in the image processing device 12 and A4, A3, B4, B5, etc., are written here.

The type of paper 209 indicates the type of the paper used for the jobs in the image processing device 12 and plain paper, tabbed paper, OHP, etc., are written here.

The finishing method 210 indicates contents of job setting in the image processing device 12, and contents of printing setting such as “duplex/single-side printing”, “staple printing”, and “N-Up printing” are written for the printing and copying jobs, contents of scanning setting such as “scanning resolution” and “destination address” are written for the scanning job, and contents of faxing setting such as “telephone number of fax sender and receiver” are written for the faxing job.

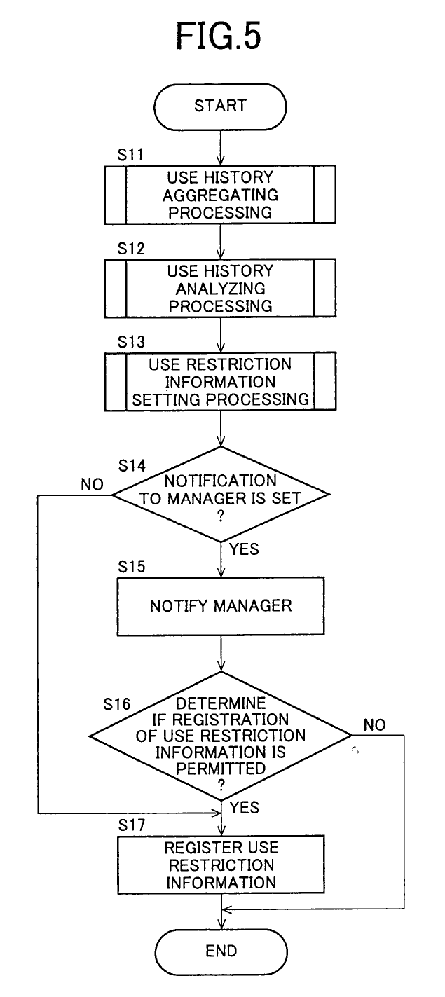

FIG. 5 is a flow chart for description of one example of processing of reading in the use history data stored in the data holding portion 113, aggregating the use history data of a specified user, analyzing a using tendency of the user, and thereafter, setting the use restriction information of the image processing device 12 for the user, in the data control portion 112 of the external server 11.

Firstly, the external server 11, by the data control portion 112, reads in the use history data stored in the data holding portion 113, aggregates data of the items relevant to the specified user, and outputs the result of the aggregation (step S11). Next, the data control portion 112 reads in the aggregation result output at step S11 and the analytical index data stored in the data holding portion 113, analyzes the use history based on the selected analytical index data, and outputs the result of the analysis (step S12). Thereafter, the data control portion 112 reads in the analysis result output at step S12 and the use restriction index data stored in the data holding portion 113 and sets the use restriction information based on the corresponding use restriction index data (step S13).

Next, the external server 11, by the data control portion 112, reads in the default use restriction information of the system stored in the data holding portion 113 and confirms setting of notification to the manager (step S14). Here, if the notification to the manager is set (in the case of Yes), then the use restriction information set at step S13 is sent to the manager terminal (information processing device 13) (step S15). On the other hand, if the notification to the manager is not set (in the case of No), then the use restriction information set at step S13 is registered in the data holding portion 113 (step S17).

At step S15, the manager who has received the use restriction information gives a notice, from the manager terminal to the external server 11, of whether to permit the registration of the use restriction information. It may also be so arranged that the manager will send the use restriction information after compiling the information.

The external server 11, by the data control portion 112, checks whether or not of the permission of the registration of the use restriction information notified from the manager terminal (step S16) and if the registration is permitted (in the case of Yes), then the process goes to step S17 and the use restriction information is registered in the data holding portion 113. On the other hand, if the registration is not permitted (in the case of No), then the process immediately comes to the end.

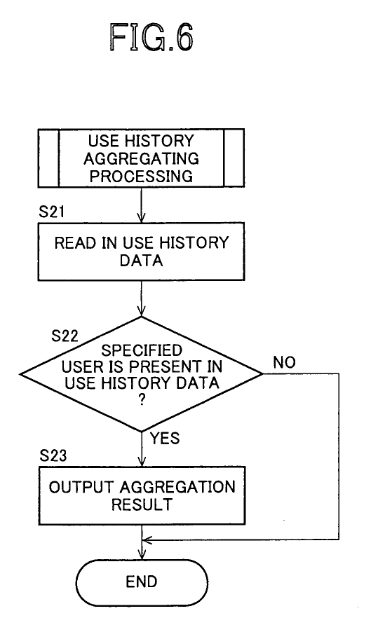

FIG. 6 is a flow chart for description of one example of processing of reading in the use history data stored in the data holding portion 113, aggregating the data for the specified user, and storing the aggregation result in the data holding portion 113, at the data control portion 112 of the external server 11. This example represents a detailed description of the processing of step S11 shown in FIG. 5.

Firstly, the external server 11, by the data control portion 112, reads in the use history data stored in the data holding portion 113 (step S21). Next, the data control portion 112 searches for the specified user from the use history data (step S22). Here, if the specified user is present (in the case of Yes), then the process goes to step S23 and if the specified user is not present (in the case of No), then the entire processing of setting the use restriction information is terminated.

If the specified user is present at step S22, then the external server, by the data control portion 112, aggregates the data of the items of the specified user that are present in the use history data (step S23). For example, when the specified user is “user_A”, in the user history data shown in FIG. 4, “user_A appears in the log-in name of the job ID “000001” and “000004” and accordingly, the job mode, the number of monochrome sheets, and the number of color sheets of each of these jobs are taken out.

In this case, since the job mode is “PRINT” and the number of monochrome sheets is 0 and 3, respectively and the numbers of color sheets is 10 and 0, respectively, 3 is added to the numerical value of “print:monochrome” and 10 is added to the numerical value of “print:color” for “user_A” of the use history data described later. When a plurality of job modes are applicable as the result of searching, the data control portion 112 repeats similar processing and stores the aggregation result in the data holding portion 113. The specified user may be a plurality of users or groups.

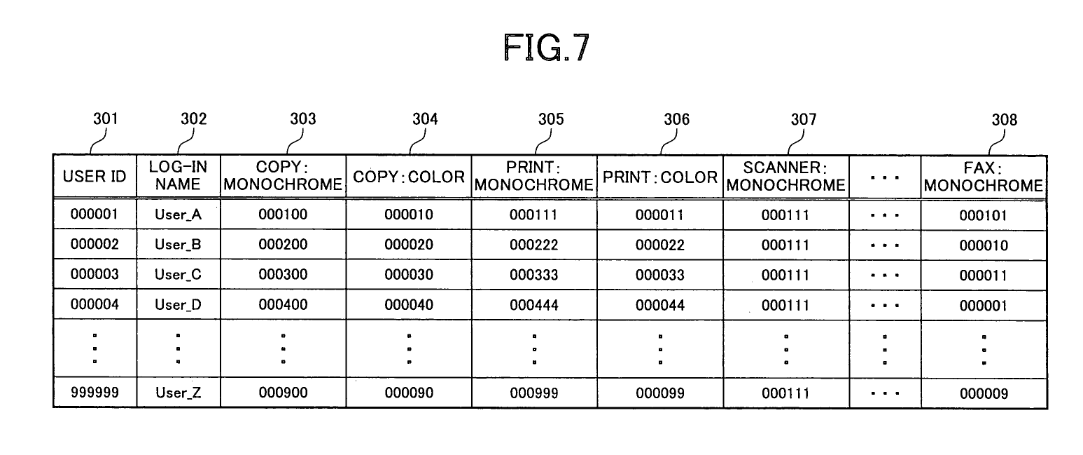

FIG. 7 is a chart of one example of the aggregation result stored in the data holding portion 113 of the external server 11. This aggregation result is the result of aggregation output in the aggregating processing shown in FIG. 6 and includes a user ID 301, a log-in name 302, a copy:monochrome 303, a copy:color 304, a print:monochrome 305, a print:color 306, a scanner:monochrome 307, and a fax:monochrome 308.

The user ID 301 is identifying information generated to distinguish users uniquely by the data control portion 112 of the external server 11.

The log-in name 302 is a log-in name used by the user at the time of logging in the image processing device 12.

The copy:monochrome 303, the copy:color 304, the print:monochrome 305, the print:color 306, the scanner:monochrome 307, and the fax:monochrome 308 mean the total number of sheets for respective jobs executed by the user on the image processing device 12, and the total number of sheets of paper used for printing in respective colors are written in the case of the printing or copying job, the total number of sheets of scanned document is written in the case of the scanning job, and the total number of sheets of printed paper in the fax reception or the total number of sheets of scanned document in the fax transmission is written in the case of the faxing job. For example, it is shown that the “user_A” recorded with the user ID “000001” used, during a specified period of time, 100 sheets for the monochrome copy, 10 sheets for the color copy, 111 sheets for the monochrome print, 11 sheets for the color print, 111 sheets for the monochrome scanning, and 101 sheets for the monochrome faxing.

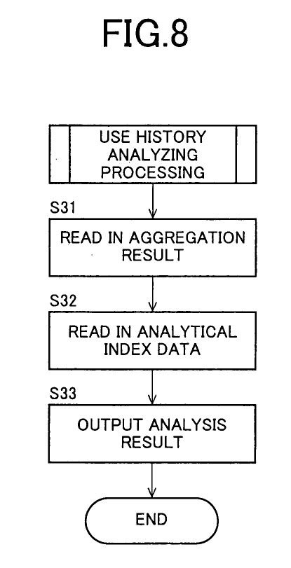

FIG. 8 is a flow chart for description of one example of processing of reading in the aggregation result and the analytical index data stored in the data holding portion 113, analyzing on the basis of the analytical index data for the specified user, and storing the result of analysis in the data holding portion 113, at the data control portion 112 of the external server 11. This example represents detailed description of the processing of step S12 shown in FIG. 5.

Firstly, the external server 11, by the data control portion 112, reads in the aggregation result stored in the data holding portion 113 (step S31), then reads in specified analytical index data from the analytical index data stored in the data holding portion 113 (step S32), and thereafter, calculates, for the aggregation result, data based on analysis items of the specified analytical index data and stores the result of analysis in the data holding portion 113 (step S33).

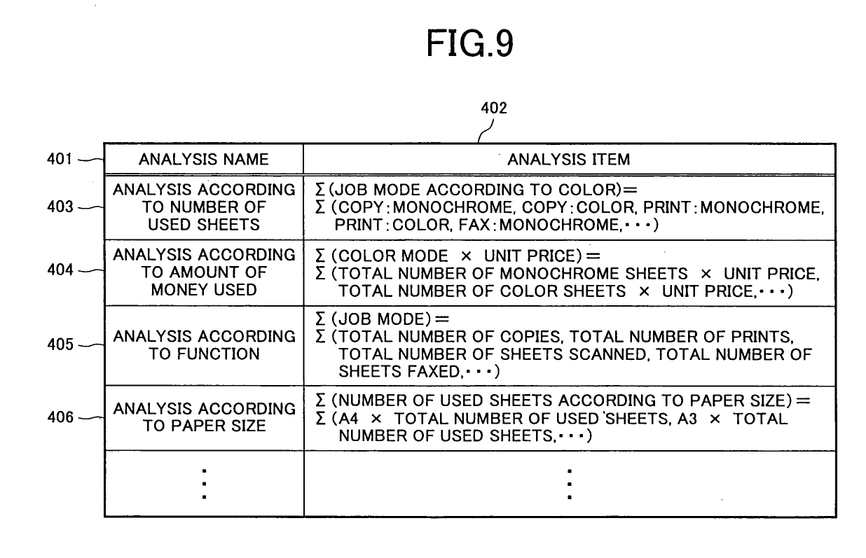

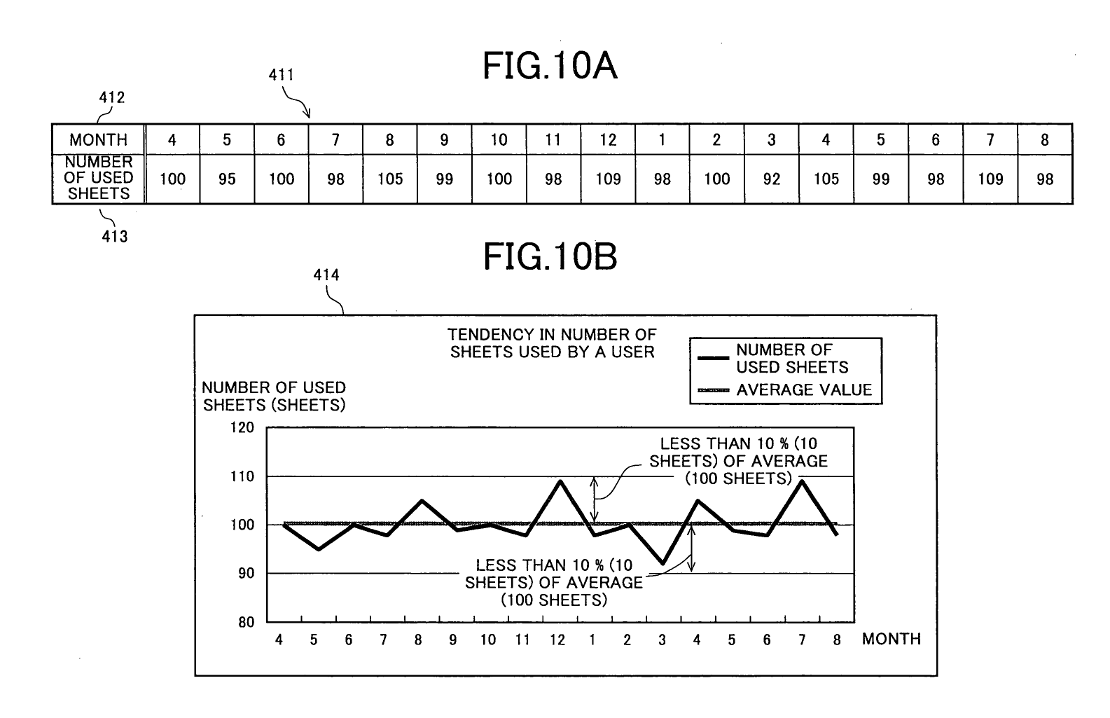

For example, when an analysis according to the number of used sheets 403 shown in FIG. 9 described later is specified, the copy:monochrome, the copy:color, the print:monochrome, the print:color, the fax:monochrome are specified as the analysis item and accordingly, with respect to the “user_A” with the user ID “000001” shown in FIG. 7, numeral values written in items of the copy:monochrome 303, the copy:color 304, the print:monochrome 305, the print:color 306, the scanner:monochrome 307, and the fax:monochrome 308, namely, 100 sheets, 10 sheets, 111 sheets, 11 sheets, 111 sheets, and 101 sheets, are added up and a total value of the number of used sheets for each period is calculated as shown in FIGS. 10A and 10B described later and is stored in the data holding portion 113.

FIG. 9 is a chart of one example of the analytical index data stored in the data holding portion 113 of the external server 11. The analytical index data to be read in at step S32 shown in FIG. 8 includes an analysis name 401 and an analysis item 402. The analysis name 401 indicates a designation of each analysis. The analysis item 402 indicates the name of such item of the aggregation result that is necessary for performing the analysis. For example, in the case of the analysis according to the number of used sheets 403, this is an analysis focusing on the number of sheets used in the image processing device 12 and indicates the total number of sheets for the job modes for each color of the aggregation result during the specified period, namely, summing up of the numerical values of the copy:monochrome 303, the copy:color 304, the print:monochrome 305, the print:color 306, the scanner:monochrome 307, and the fax:monochrome 308, shown in FIG. 7.

Likewise, in the case of an analysis according to the spent amount of money 404, this is an analysis focusing on the amount of money spent in the image processing device 12 and indicates summing up products of the number of used sheets for each color (monochrome or color) of the aggregation result and the unit price set by the system, such as unit price setting 605 shown in FIG. 20 described later.

An analysis according to the functions 405 is an analysis focusing on the functions used in the image processing device 12 and indicates summing up the total number of sheets for each job mode used in the image processing device 12, namely, the summing up the total number of sheets for each of the copying, printing, scanning, faxing, etc.

An analysis according to the paper sizes 406 is an analysis focusing on the size of the paper used in the image processing device 12 and indicates the summing up the total number of sheets for each paper size used in the image processing device 12, namely, the summing up the total number of sheets for each of A4, A3, etc.

The above configuration enables performing the use restriction according to the allowable number of printed sheets, the allowable upper-limit amount of money, the allowable functions such as copying and printing.

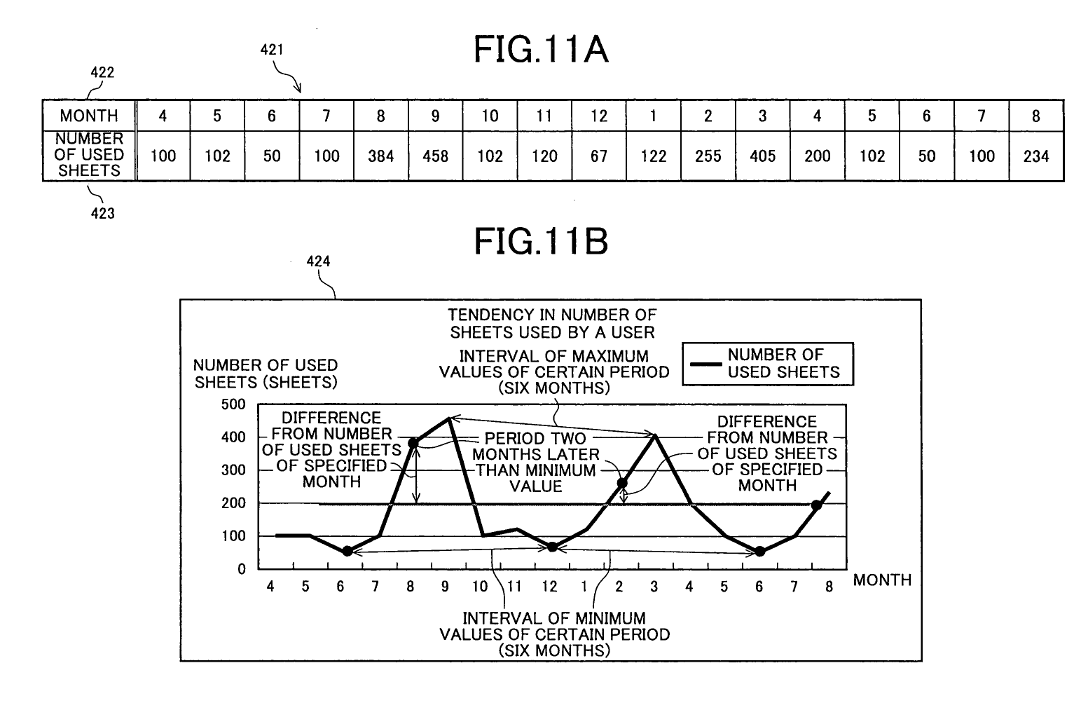

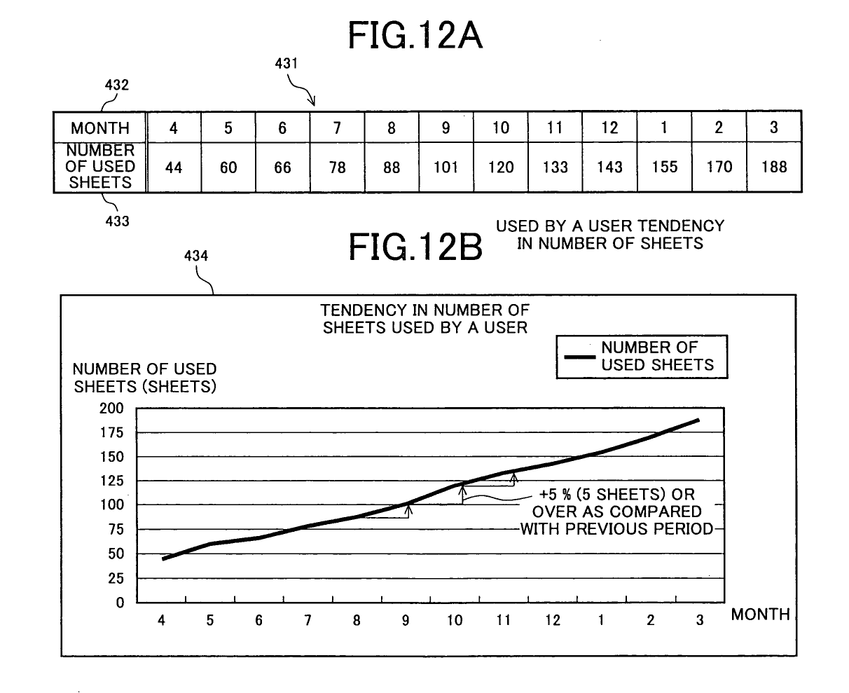

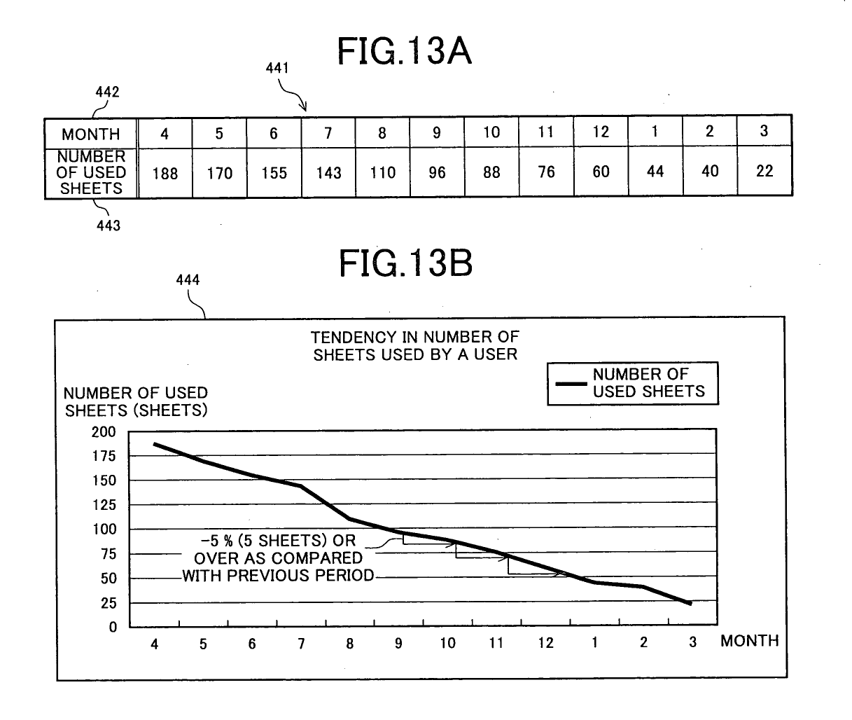

FIGS. 10A to 13B are charts of one example of the analysis result stored in the data holding portion 113 of the external server 11. FIGS. 10A and 10B illustrate an example of an average type, FIGS. 11A and 11B illustrate an example of a periodic type, FIGS. 12A and 12B illustrate an example of ascending type, and FIGS. 13A and 13B illustrate an example of a descending type.

In FIGS. 10A and 10B, the analysis result to be output in the analyzing processing at step S12 shown in FIG. 5 described above includes a table 411 shown in FIG. 10A and a graph 414 shown in FIG. 10B.

The table 411, containing the month 412 as the specified period and the number of used sheets 413, shows the number of sheets used in each month. With respect to the period of the analysis, the month 412 is changed according to the period specified in the aggregation result and the number of used sheets 413 as well is changed accordingly.

The graph 414 is a visually represented diagram, in which the horizontal axis shows the month 412 of the table 411 taken and the vertical axis shows the number of used sheets 413. It may be so arranged that this graph 414 will be available for inspection as the data to be notified to the system manager. From the result of such analysis, it is known that the tendency in the number of sheets used by the user belongs to the average type.

In FIGS. 11A and 11B, the analysis result output in the analyzing processing at step S12 shown in FIG. 5 described above includes a table 421 shown in FIG. 11A and a graph 424 shown in FIG. 11B.

The table 421, containing the month 422 as the specified period and the number of used sheets 423, shows the number of sheets used in each month. With respect to the period of the analysis, the month 422 is changed according to the period specified in the aggregation result and the number of used sheets 413 as well is changed accordingly.

The graph 424 is a visually represented diagram, in which the horizontal axis shows the month 422 of the table 421 and the vertical axis shows the number of used sheets 423. It may be so arranged that this graph 424 will be available for inspection as the data to be notified to the system manager. From the result of such analysis, it is known that the tendency in the number of sheets used by the user belongs to the periodic type.

In FIGS. 12A and 12B, the analysis result output in the analyzing processing at step S12 shown in FIG. 5 described above includes a table 431 shown in FIG. 12A and a graph 434 shown in FIG. 12B.

The table 431, containing the month 432 as the specified period and the number of used sheets 433, shows the number of sheets used in each month. With respect to the period of the analysis, the month 432 is changed according to the period specified in the aggregation result and the number of used sheets 433 as well is changed accordingly.

The graph 434 is a visually represented diagram, in which the horizontal axis shows the month 432 of the table 431 and the vertical axis shows the number of used sheets 433. It may be so arranged that this graph 434 will be available for inspection as the data to be notified to the system manager. From the result of such an analysis, it is known that the tendency in the number of sheets used by the user belongs to the ascending type.

In FIGS. 13A and 13B, the analysis result to be output in the analyzing processing at step S12 shown in FIG. 5 described above includes a table 441 shown in FIG. 13A and a graph 444 shown in FIG. 13B.

The table 441, containing the month 442 as the specified period and the number of used sheets 443, shows the number of sheets used in each month. With respect to the period of the analysis, the month 442 is changed according to the period specified in the aggregation result and the number of used sheets 443 as well is changed accordingly.

The graph 444 is a visually represented diagram, in which the horizontal axis shows the month 442 of the table 441 and the vertical axis shows the number of used sheets 443. It may be so arranged that this graph 444 will be available for inspection as the data to be notified to the system manager. From the result of such an analysis, it is known that the tendency in the number of sheets used by the user belongs to the descending type.

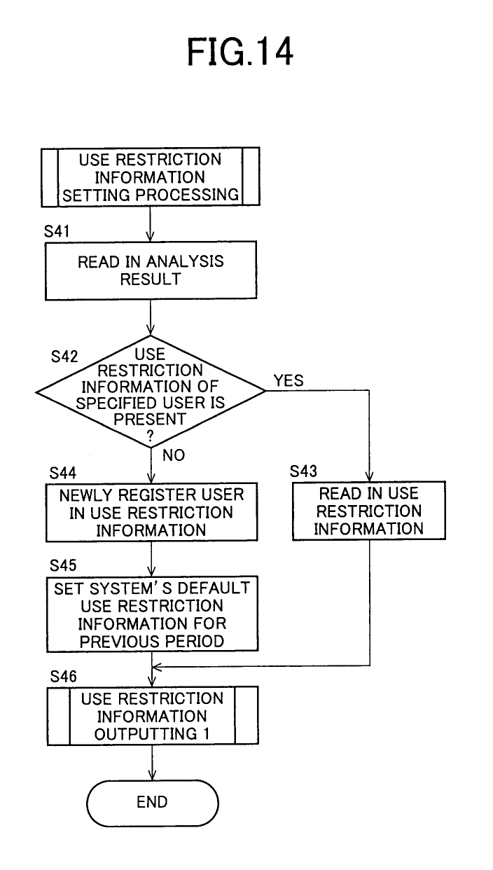

FIG. 14 is a flow chart for description of one example of processing of setting the use restriction information based on the specified use restriction index data, from the result of analysis by the analyzing processing of step S12 shown in FIG. 5, and storing the use restriction information in the data holding portion 113, at the data control portion 112 of the external server 11. This example represents detailed description of the processing of step S13 shown in FIG. 5.

Firstly, the external server 11, by the data control portion 112, reads in the analysis result stored in the data holding portion 113 (step S41) and then reads in the use restriction information stored in the data holding portion 113 and searches for the specified user in the information (step S42). Here, if the specified user is present (in the case of Yes), then the data of the specified user is read in from the use restriction information stored in the data holding portion 113 (step S43). On the other hand, if the specified user is not present (in the case of No), the specified user is newly registered in the use restriction information of the data holding portion 113 (step S44).

Next, the external server 11, by the data control portion 112, sets default use restriction information of the system for a period previous to the period specified in the use restriction information of the newly registered user at step S44 (step S45) and the process goes to step S46.

Lastly, the external server 11, by the data control portion 112, moves to a user restriction information outputting 1 and creates the use restriction information based on the specified use restriction index data, from the analysis result stored in the data holding portion 113 and stores the information in the data holding portion 113 (step S46).

Conventionally, when the manager manually performs setting of the use restriction for each user, there have been cases where the use restriction is set that is unsuitable for the using situation of the user, such as setting a severe use restriction to the user of a frequent use. However, the above configuration enables setting an appropriate use restriction for each user based on the using situation of the user from the past.

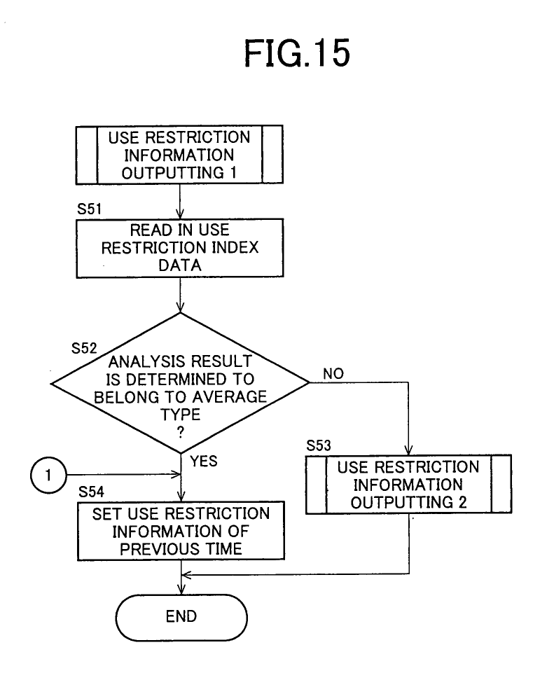

FIG. 15 is a flow chart for description of one example of processing of setting the use restriction information based on the analysis result and the use restriction index data stored in the data holding portion 113 for the use restriction information of the user read in at step S43 shown in FIG. 14 and storing the information in the data holding portion 113, at the data control portion 113 of the external server 11. This example represents detailed description of the processing of step S46 shown in FIG. 14. Here, it is determined according to the use restriction index data whether the analysis result belongs to the average type.

Firstly, the external server 11, by the data control portion 112, reads in the use restriction index data stored in the data holding portion 113 (step S51). Then, the data control portion 112, in accordance with the use restriction index data, from the analysis result stored in the data holding portion 113, refers to the average value of the number of sheets used for all periods, calculates the absolute value of the difference between the average value and the number of used sheets for each period, and determines whether the absolute value of the difference from the average value is less than 10% (step S52). Here, if the absolute value of the difference from the average value is not less than 10%, then it is determined that the analysis result does not belong to the average type (in the case of No) and the process goes to a use restriction information outputting 2 (step S53). On the other hand, if the absolute value of the difference from the average value is less than 10%, then it is determined that the analysis result belong to the average type (in the case of Yes) and the data control portion 112 sets the current use restriction information read-in by it as the use restriction information for the next period and stores it in the data holding portion 113 (step S54).

In the determining processing at step S52, for example, in the case of the graph 414 shown in FIG. 10B, since the average value is 100 sheets, the absolute value of the difference between the number of used sheets for each period and the average value is less than 10% (less than 10 sheets) and the graph 414 is determined to belong to the average type.

It may be so arranged that the external server 11, by the data control portion 112, will periodically change the use restriction setting for each user. Since the using situation of the user changes, the use restriction according to the change may be made by periodically changing the use restriction setting.

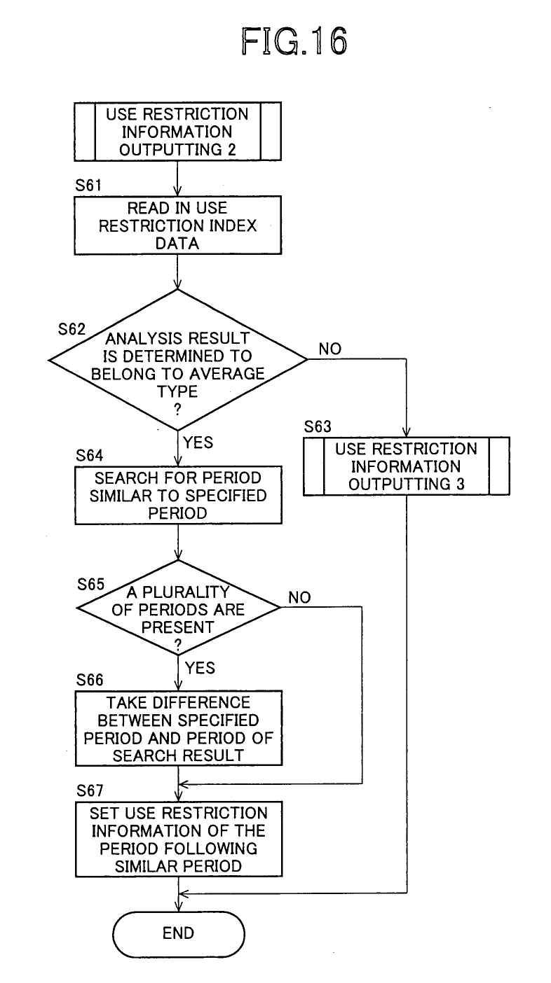

FIG. 16 is a flow chart for description of another example of processing of setting the use restriction information based on the analysis result and the use restriction index data stored in the data holding portion 113, for the use restriction information of the user read in at step S43 shown in FIG. 14 and storing the information in the data holding portion 113, at the data control portion 112 of the external server 11. This example represents detailed description of the processing of step S53 shown in FIG. 15. Here, it is determined according to the use restriction index data whether the analysis result belongs to the periodic type.

Firstly, the external server 11, by the data control portion 112, reads in the use restriction index data stored in the data holding portion 113 (step S61). Then, the data control portion 112, in accordance with the use restriction index data, from the analysis result stored in the data holding portion 113, refers to the maximum and the minimum values of the number of used sheets for a certain period, calculates the cycle of the number of used sheets, and determines whether the specified period and periods previous to and subsequent to the specified period correspond to the cycle (step S62).

Here, for example, in the case of the graph 424 shown in FIG. 11B, by referring to the maximum values obtained in September and March and the minimum values obtained in June and December, the cycle of 6 months is calculated. Next, since August (of the year) as the specified period and July as the period previous thereto correspond to August and July of the previous year and February and January, respectively, as similar periods, the analysis result is determined to belong to the periodic type. In FIGS. 11A and 11B, April, May, June, July, and August appear twice and distinction is made by calling the left-hand side of the drawing as the previous year and right-hand side of the drawing as the current year.

If the analysis result is determined to belong to the periodic type at step S62 (in the case of Yes), then the data control portion 112 calculates to which period counted from the period of the minimum value the specified period corresponds and searches for similar periods (step S64). For example, in the case of the graph 424 shown in FIG. 11B, since the specified period comes after the neighboring period of the minimum value by two months, the data control portion 112 searches for a period comes after another certain period of the minimum value by two months. In this case, August of the previous year and February of this year are output as the result of searching.

On the other hand, at step S62, if it is determined that the number of used sheets has no periodicity (in the case of No), then the process goes to a use restriction information outputting 3 (step S63).

Then, the external server 11, by the data control portion 112, judges whether a plurality of corresponding periods are output at step S64 (step S65) and, if a plurality of corresponding periods are present (in the case of Yes), calculates the absolute value of the difference between each of the corresponding periods and the specified period and outputs the period with a small absolute value of the difference as the corresponding period (step S66). For example, in the case of the graph 424, since August of the previous year and February are output as the corresponding periods, calculation is made to obtain the absolute value of the difference between the number of used sheets in each of these corresponding periods and the number of used sheets (234 sheets) of August (of current year), the specified period. In this case, since the absolute value of the difference between the numbers of sheets used in Augusts of the previous and the current year is 150 sheets and the absolute value of the difference between those in August of the previous year and in February is 21 sheets, February is output as the corresponding period.

Lastly, the external server 11, by the data control portion 112, reads in the use restriction information for the period following the similar period out of the read-in use restriction information and stores the information in the data holding portion 113 (step S67). For example, in the case of the example shown in FIGS. 11A and 11B, since February is determined to be the similar period, the use restriction information of March is set as the use restriction information of September of the current year and this is stored in the data holding portion 113.

As seen above, the external server 11, by the data control portion 112, judges whether the using situation of the user changes periodically based on the analysis result of the use history data, and if the situation changes periodically, it may be so arranged that the use restriction setting will be made based on the use restriction setting of the previous cycle. For example, for the user who frequently prints reports at the end of the month, setting may be made to enable him to do much printing at the end of the month.

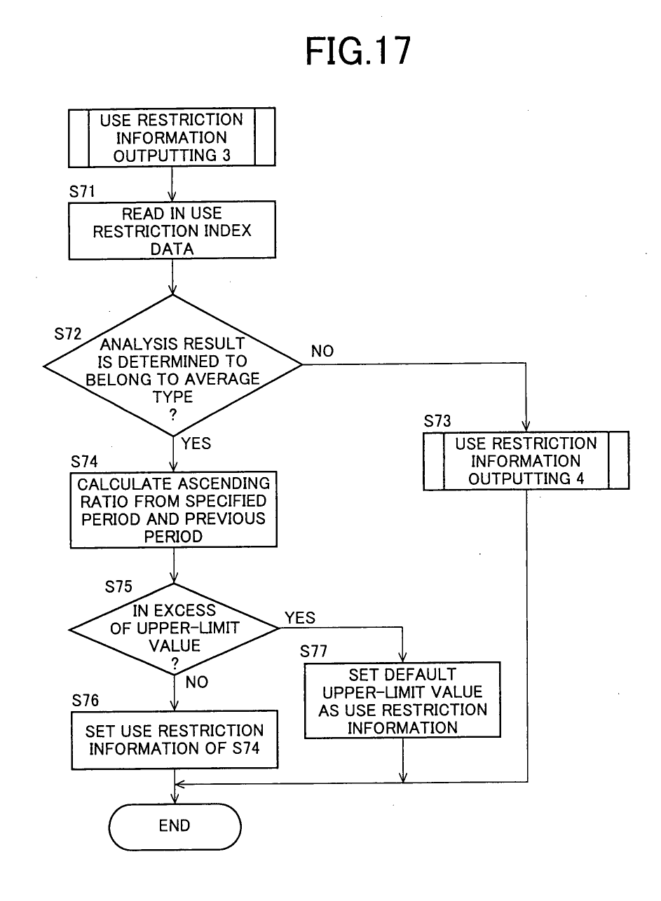

FIG. 17 is a flow chart for description of another example of processing of setting the use restriction information based on the analysis result and the use restriction index data stored in the data holding portion 113, for the use restriction information of the user read in at step S43 shown in FIG. 14 and storing the information in the data holding portion 113, at the data control portion 112 of the external server 11. This example represents detailed description of the processing of step S63 shown in FIG. 16. Here, it is determined according to the use restriction index data whether the analysis result belongs to the ascending type.

Firstly, the external server 11, by the data control portion 112, reads in the use restriction index data stored in the data holding portion 113 (step S71). Then, the data control portion 112, in accordance with the use restriction index data, from the analysis result stored in the data holding portion 113, calculates whether the number of used sheets for each period increases with a predetermined ascending ratio (here, +5% or more) as compared with the number of used sheets for the period previous thereto and determines whether the analysis result belongs to the ascending type (step S72). Here, for example, in the case of the graph 434 shown in FIG. 12B, since the number of used sheets in August is 88 sheets and the number of used sheets in September is 101 sheets, the number of used sheets increases by 14% and likewise, the numbers of used sheets in other months increase by 5% or more, the analysis result is determined to belong to the ascending type.

If the analysis result is determined to belong to the ascending type as seen above (in the case of Yes), the data control portion 112 obtains the difference in the number of used sheets between the specified period and the period previous thereto, calculates a ratio of ascending, and multiplies the number of used sheets for the specified period by the ascending ratio (step S74). For example, in the case of the graph 434 shown in FIG. 12B, since the specified period is March, the difference in the numbers of used sheets between February and March is 18 sheets and the ascending ratio is calculated to be 6%. In this case, the number of used sheets in April is calculated to be 199 sheets.

On the other hand, if the analysis result is determined not to belong to the ascending type as in the case of a graph 444 shown in FIG. 13B (in the case of No), then the process goes to a use restriction information outputting 4 (step S73).

Next, the external server 11, by the data control portion 112, compares the result of step S74 (199 sheets in April) with the default upper-limit value of the system, determines whether the result is in excess of the upper-limit value (step S75), and, if the result is determined not to be in excess of the upper-limit value (in the case of No), sets the result of step S74 as the use restriction information and stores the result in the data holding portion 113 (step S76). For example, in the case of a table 600 shown in FIG. 20 described later, since the system's default upper-limit value of the total number of used sheets is described as 500 sheets per month, the result is determined not to be in excess of the upper-limit value and 199 sheets, the result of step S74 are set as the use restriction information.

On the other hand, at step S75, if the data control portion 112 determines that the result is in excess of the upper-limit value (in the case of Yes), then the default upper-limit value of the system stored in the data holding portion 113 as shown in FIG. 20 is set as the use restriction information and stored in the data holding portion 113 (step S77).

It may be so arranged that, as seen above, the external server 11, by the data control portion 112, judges, based on the result of the analysis of the use history data, whether the using situation of the user has an increasing tendency, and if the using situation has an increasing tendency, the use restriction will be set so that the user may use a greater number of sheets this time than the previous time. Since, when the frequency of use by the user in business is increasing, it can be considered that the number of sheets being printed on the image processing device 12 will increase, and therefore, setting may be made so as to enable the device to print a greater number of sheets than that of the previous time.

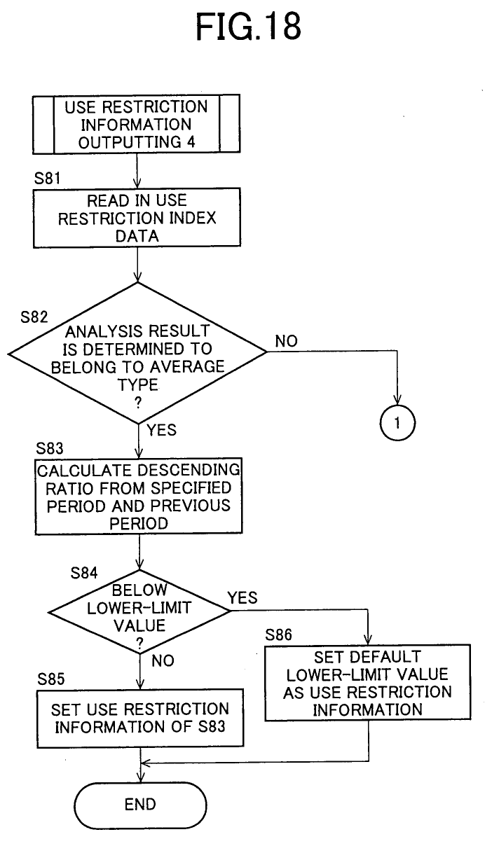

FIG. 18 is a flow chart for description of another example of processing of setting the use restriction information based on the analysis result and the use restriction index data stored in the data holding portion 113, for the use restriction information of the user read in at step S43 shown in FIG. 14 and storing the information in the data holding portion, at the data control portion 112 of the external server 11. This example represents detailed description of the processing of step S73 shown in FIG. 17. Here, it is determined according to the use restriction index data whether the analysis result belongs to the descending type.

Firstly, the external server 11, by the data control portion 112, reads in the use restriction index data stored in the data holding portion 113 (step S81). Then, the data control portion 112, in accordance with the use restriction index data, from the analysis result stored in the data holding portion 113, calculates whether the number of used sheets for each period decreases with a predetermined descending ratio (here, −5% or more) as compared with the number of used sheets for the period previous thereto and determines whether the analysis result belongs to the descending type (step S82). Here, for example, in the case of the graph 444 shown in FIG. 13B, since, with the number of used sheets in August is 110 sheets and the number of used sheets in September is 96 sheets, the number of used sheets decreases by 14% and likewise, the numbers of used sheets in other months decrease by 5% or more, the analysis result is determined to belong to the descending type.

If the analysis result is determined to belong to the descending type as seen above (in the case of Yes), the data control portion 112 obtains the difference in the numbers of used sheets between the specified period and the period previous thereto, calculates a ratio of descending, and multiplies the number of used sheets for the specified period by the descending ratio (step S83). For example, in the case of the graph 444 shown in FIG. 13B, since the specified period is March, the difference in the numbers of used sheets between February and March is 18 sheets and the descending ratio is calculated to be 6%. In this case, the number of used sheets in April is calculated to be 20 sheets.

On the other hand, if the analysis result is determined not to belong to the descending type as in the case of a graph 434 shown in FIG. 12B (in the case of No), then the process goes to step S54 shown in FIG. 15.

Next, the external server 11, by the data control portion 112, compares the result of step S83 (20 sheets in April) with the default lower-limit value of the system, determines whether the result is below the lower-limit value (step S84), and, if the result is determined not to be below the lower-limit value (in the case of No), sets the result of step S83 as the use restriction information and stores the result in the data holding portion 113 (step S85).

On the other hand, at step S84, if the data control portion 112 determines that the result is below the lower-limit value (in the case of Yes), then the default lower-limit value of the system stored in the data holding portion 113 as shown in FIG. 20 is set as the use restriction information and stored in the data holding portion 113 (step S86). For example, in the case of the table 600 shown in FIG. 20, since the system's default lower-limit value of the total number of used sheets is described as 100 sheets per month, the result is determined to be below the lower-limit value and 100 sheets, the default value of the system, are set as the use restriction information.

It may be so arranged that, as seen above, the external server 11, by the data control portion 112, judges, based on the result of the analysis of the use history data, whether the using situation of the user has a decreasing tendency, and if the using situation has the decreasing tendency, the use restriction will be set so that the number of used sheets may be smaller this time than the previous time. Since, when the frequency of use by the user in business is decreasing, it can be considered that the number of sheets being printed on the image processing device 12 will decrease, and therefore, the use restriction is set that is severer than that of the previous time.

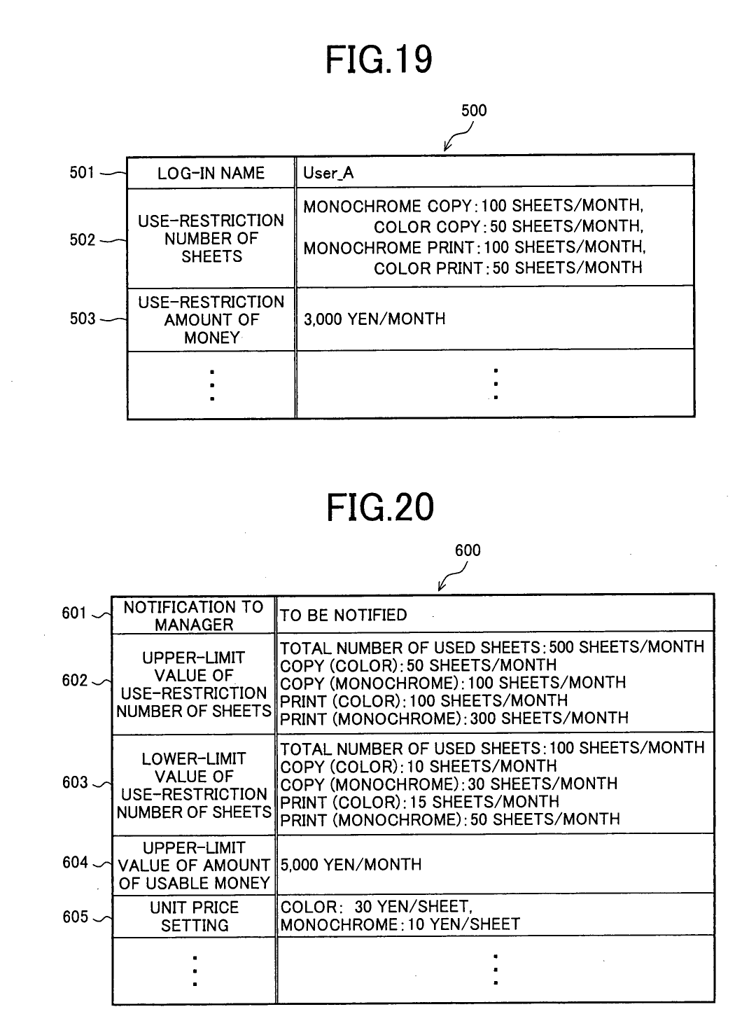

FIG. 19 is a chart of one example of the use restriction information of the user stored in the data holding portion 113 of the external server 11. User restriction information 500 output at step S46 described earlier represents the information of the use restriction for the user in using the image processing device 12 and includes a log-in name 501, a use-restriction number of sheets 502, and a use-restriction amount of money 503.

The log-in name 501 indicates the user who uses the image processing device 12 and, for example, in FIG. 19, “user_A” is written as the long-in name.

The use-restriction number of sheets 502 indicates the upper-limit value of the number of sheets up to which the user described in the log-in name 501 can print or copy using the image processing device 12 and in the case of the example shown in FIG. 19, it is written that the user may use up to 100 sheets for the monochrome copy, up to 50 sheets for the color copy, up to 100 sheets for the monochrome print, and up to 50 sheets for the color print, respectively per month.

Likewise, the use-restriction amount of money 503 indicates the upper-limit value of the amount of money up to which the user may use the image processing device 12 and for example, in the case of the example shown in FIG. 19, it is written that the user may use up to 3,000 yen per month.

FIG. 20 is a chart of one example of the system's default use restriction information stored in the data holding portion 113 of the external server 11. System's default use restriction information 600 referred to at step S75 shown in FIG. 17 and at step S84 shown in FIG. 18 represents the use restriction information as a standard to the image processing device 12 and includes a notice to manager 601, an upper-limit value of the use-restriction number of sheets 602, a lower-limit value of the use-restriction number of sheets 603, an upper-limit value of the amount of usable money 604, and a unit price setting 605.

The notice to manager 601 indicates whether to notify the manager of the use restriction information set by the external server 11.

The upper-limit value of the use-restriction number of sheets 602 indicates the upper-limit value as a standard of the system of the number of sheets up to which the image processing device 12 may be used and in the case of the example shown in FIG. 20, it is written that the image processing device 12 may be used up to 500 sheets as the total number of used sheets including up to 100 sheets for the monochrome copy, up to 50 sheets for the color copy, up to 300 sheets for the monochrome print, and up to 100 sheets for the color print, respectively per month.

Likewise, the lower-limit value of the use-restriction number of sheets 603 indicates the lower-limit value as a standard of the system of the number of sheets up to which the image processing device 12 may be used and in the case of the example shown in FIG. 20, it is written that the image processing device 12 may be used up to 100 sheets as the total number of used sheets including up to 30 sheets for the monochrome copy, up to 10 sheets for the color copy, up to 50 sheets for the monochrome print, and up to 15 sheets for the color print, respectively per month.

The upper-limit value of the amount of usable money 604 indicates the upper-limit value as a standard of the system of the amount of money up to which the image processing device 12 may be used and in the case of the example shown in FIG. 20, it is written that the image processing device 12 may be used up to 5000 yen per month.

The unit price setting 605 indicates the amount of used money as a standard of the system for the number of used sheets for respective colors at the time of executing jobs on the image processing device 12 and in the case of the example shown in FIG. 20, it is written that the amount of usable money is 30 yen for one sheet in color and 10 yen for one sheet in monochrome.

It may be so arranged that the default use restriction information of the system may be edited by the manager.

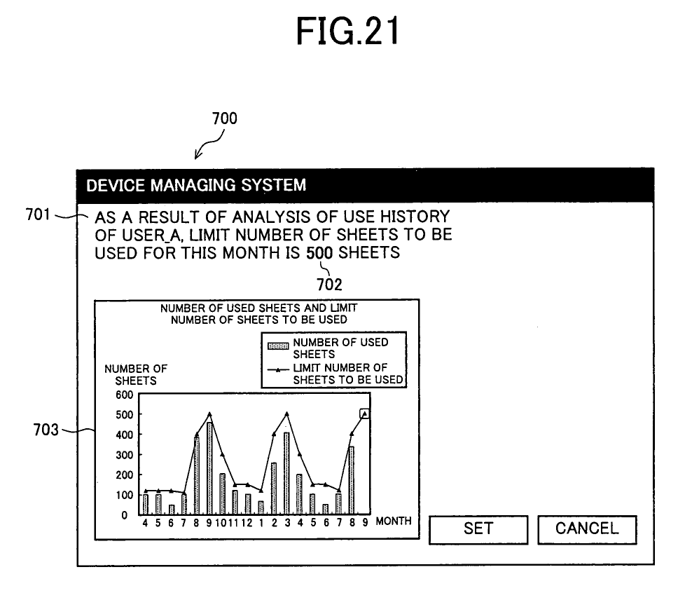

FIG. 21 is a diagram of one example of a screen displayed on the information processing device 13 as the manager terminal when the external server 11 notifies the manager of the use restriction information output at step S13 shown in FIG. 5. A notice screen 700 includes a user name 701 related to the setting, a use restriction 702 for the next period, and a graph 703 of using tendency related to the user.

The user name 701 indicates the name of the user for whom the use restriction information of the image processing device 12 is set.

The use restriction 702 for the next period indicates the value of the use restriction information output at step S13 shown in FIG. 5 described earlier. It may be so arranged that at the data control portion 132 of the information processing device 13, the manager will edit the received use restriction information and send a request for correction of the use restriction information to the external server 11 by way of the communicating portion 131.

The graph 703 of using tendency is a visual representation of the number of used sheets and the use restriction information of the past, referring to the analysis result output at step 12 shown in FIG. 5 described earlier.

It may be so arranged that as seen above, the external server 11, by the data control portion 112, will notify the information processing device 13 of the use restriction information of the user by way of the communicating portion 111 and change the use restriction based on the correction request from the information processing device 13. As seen above, when the use restriction information is automatically set by the external server 11, the correction of the use restriction may appropriately be performed by the manager terminal.

While description has been made of each embodiment, focusing on each function of the printing managing apparatus of the present invention, the present invention may also assume a form of printing managing method, as described as the method of executing respective steps in the printing managing apparatus. The present invention may also assume a form of printing managing program that enables a computer to work as the printing managing apparatus, in the same manner as the printing managing apparatus having these respective functions, and a form of recording medium on which the printing managing program is recorded.

Description will be made of the embodiment of the recording medium that records the program or data for realizing the functions of printing managing according to the present invention. Conceivable recording medium is, specifically, a CD-ROM (-R/-RW), a magneto-optical disk, a DVD-ROM (-R/-RW/-RAM), an FD, an HD, a BD, a flash memory, a memory card, a memory stick, and other various kinds of ROMs, RAMs, etc., and by recording on these recording media, and circulating, the program for causing the computer to execute the functions of the apparatus according to each embodiment of the present invention described above and realizing the function of the printing managing, the realization of such function will be facilitated. By installing the recording medium described above in the information processing device such as the computer and reading out the program by the information processing device or by storing the program in the storage medium provided in the information processing device and reading out the program as required, the function of the printing managing according to the present invention can be executed.

As described above, the capability of automatically setting the use restriction based on the result of analysis of the use history of the image processing device enables a reduction of the manager's time for setting and the capability of setting the use restriction according to the using situation of the user enables a user to obtain an improved convenience of the image processing device.

According to the present invention, the capability of automatically setting the use restriction based on the result of analysis of the use history of the image processing device, enables a reduction of the manager's time for setting and, by the capability of setting the use restriction according to the using situation of the user enables a user to obtain an improved convenience of the image processing device.

1. A printing managing apparatus connectable to an image processing device by way of a network, comprising:
a communicating portion that receives a job processing result from the image processing device;
a use history data holding portion that stores the job processing result as use history data of the image processing device;
an analyzing portion that analyzes using situation for each user who has executed job processing based on the use history data;
a use restriction setting portion that performs setting of use restriction of the image processing device for each user based on the result of the analysis by the analyzing portion.

2. The printing managing apparatus as defined in claim 1, wherein
the use restriction setting portion periodically changes the setting of the use restriction for each user.

3. The printing managing apparatus as defined in claim 1, wherein
the use restriction setting portion judges whether the using situation of the user changes periodically based on the result of the analysis by the analyzing portion, and if the situation changes periodically, performs the setting of the use restriction based on the setting of the use restriction of the preceding cycle.

4. The printing managing apparatus as defined in claim 1, wherein
the use restriction setting portion judges whether the using situation of the user is in an increasing tendency based on the result of the analysis by the analyzing portion, and if the situation is in the increasing tendency, performs the setting of the use restriction so that the user may make more use of the image processing device than the previous time.

5. The printing managing apparatus as defined in claim 1, wherein
the use restriction setting portion judges whether the using situation of the user is in an decreasing tendency based on the result of the analysis by the analyzing portion, and if the situation is in the decreasing tendency, performs the setting of the use restriction so that the user may make less use of the image processing device than the previous time.

6. The printing managing apparatus as defined in claim 1, connected to a manager terminal by way of the communicating portion and equipped with a notifying portion that notifies the manager terminal of the use restriction set by the use restriction setting portion by way of the communicating portion, wherein
the use restriction setting portion changes the use restriction based on a request for correction from the manager terminal.

7. The printing managing apparatus as defined in claim 1, wherein
the use restriction is either one of an allowable number of sheets of paper, an allowable upper-limit amount of money, and an allowable function.

8. A printing managing system comprising:
the printing managing apparatus of any one of claims 1 to 7; and
an image processing device connected to the printing managing apparatus by way of a network, wherein
the image processing device executes image processing based on the use restriction for each user set by the printing managing apparatus.

9. A printing managing method performed by a printing managing apparatus connectable to an image processing device by way of a network, comprising steps of:
receiving a job processing result from the image processing device;
storing the job processing result as use history data of the image processing device;
analyzing using situation for each user who has executed job processing based on the use history data; and
performing setting of use restriction for each user of the image processing device based on the result of the analysis.

10. A program for executing a function as the printing managing apparatus as defined in claim 1.
